(19) United States
(12) Patent Application Publication
(10) Pub. No.: US 2015/0016033 A1
(43) Pub. Date: Jan. 15, 2015

(54) DISPLAY DEVICE SUBSTRATE, DISPLAY DEVICE, AND RELATED FABRICATION METHOD

(71) Applicant: Samsung Display Co. Ltd., Yongin-City (KR)

(72) Inventor: Jin Woo CHOI, Seoul (KR)

(73) Assignee: Samsung Display Co. Ltd., Yongin-City (KR)

(21) Appl. No.: 14/066,464

(22) Filed: Oct. 29, 2013

(30) Foreign Application Priority Data
Jul. 2, 2013 (KR) 10-2013-0077182

(51) Int. Cl. G06F 1/16

(52) U.S. Cl. CPC G06F 1/16
USPC 361/679.01; 264/138; 428/156; 428/157; 83/13

(57) ABSTRACT

A substrate is for use in a display device. The substrate may include a plurality of non-uniform surface portions, the non-uniform surface portions being spaced from each other and including a first non-uniform surface portion and a second non-uniform surface portion. The substrate may further include a plurality of substantially uniform surface portions having a molecular structure that is more uniform than a molecular structure of the plurality of non-uniform surface portions, the substantially uniform surface portions being spaced from each other and including a first substantially uniform surface portion that abuts each of the first non-uniform surface portion and the second non-uniform surface portion.

### CROSS-REFERENCE TO RELATED APPLICATIONS

This application claims priority to and benefit of Korean Patent Application No. 10-2013-0077182, filed on Jul. 2, 2013 in the Korean Intellectual Property Office, the disclosure of which is incorporated herein in its entirety by reference.

### BACKGROUND

1. Field of the Invention

The present invention relates to a substrate, a display device that includes the substrate, and a method for fabricating the substrate.

2. Description of the Prior Art

A display device, such as a liquid crystal display, an electrophoretic display, an organic light emitting display, a FED (Filed Emission Display), a SED (Surface-conduction Electron-emitter Display), a plasma display, or a cathode ray tube display, typically includes at least one substrate that supports other components of the display device. The substrate(s) of a display device may substantially affect the quality and/or stability of the display device.

### SUMMARY

In order to fabricate a display device substrate for use in a display device, a large-sized mother substrate may be fabricated and then divided into small-sized unit substrates through a cutting process. The display device substrate may be one of the unit substrates.

This cutting process may involve using a cutting means, for example, a knife, and may result in non-uniform surface portions of the display device substrate. The non-uniform surface portions may be cut surfaces and/or surface portions adjacent to cut surfaces and may have non-uniform molecular structures. Embodiments of the invention may minimize non-uniform surface portions of display device substrates. Advantageously, satisfactory stability, durability, impact resistance, and/or image display quality of display devices may be provided.

An embodiment of the invention may be related to a substrate for use in a display device. The substrate may include a plurality of non-uniform surface portions each having a non-uniform molecular structure. The non-uniform surface portions may be spaced from each other and may include a first non-uniform surface portion and a second non-uniform surface portion. The substrate may further include a plurality of substantially uniform surface portions each having a substantially uniform molecular structure. A molecular structure of (each of) the substantially uniform surface portions may be more uniform than a molecular structure of (each of) the non-uniform surface portions. The substantially uniform surface portions may be spaced from each other and may include a first substantially uniform surface portion that may abut each of the first non-uniform surface portion and the second non-uniform surface portion.

The first substantially uniform surface portion may be a curved surface portion.

The non-uniform surface portions and the substantially uniform surface portion may be alternately arranged.

The first substantially uniform surface portion may be recessed with respect to the first non-uniform surface portion.

The first non-uniform surface portion may be located at a first side of the substrate, and the first substantially uniform surface portion may be a surface portion of a recess at the first side of the substrate.

The first substantially uniform surface portion may be substantially semicircular in a plan view of the substrate.

The non-uniform surface portions may be respectively located at chamfered corners of the substrate.

Each of the first non-uniform surface portion and the second non-uniform surface portion may be slanted (e.g., disposed at an obtuse angle) with respect to the first substantially uniform surface portion in a plan view of the substrate.

The first substantially uniform surface portion may include a surface portion of a recess of a barrier layer of the substrate and a surface portion of a recess of a base layer of the substrate.

An embodiment of the invention may be related to a method for fabricating a display device substrate for use in a display device. The method may include the following steps: preparing a mother substrate that includes a plurality of through holes; and cutting the mother substrate in directions that pass through the through holes to separate the display device substrate from other portions of the mother substrate.

The method may include the following steps: preparing a support plate that includes a support portion and a plurality of protrusions disposed on the support portion; providing liquid plastic on the support portion such that the liquid plastic fills a space defined by the protrusions and such that each of the protrusions is surrounded by the liquid plastic; curing the liquid plastic into a solid plastic layer; and removing the support plate from the mother substrate, wherein the mother substrate includes or is the solid plastic layer.

A thickness of the solid plastic layer may be less than a height of the protrusions. The protrusions may correspond to the through holes.

The method may include the following step: providing a barrier layer material on the solid plastic layer such that each of the protrusions is surrounded by the barrier layer material. The barrier layer material may be different form the liquid plastic. The mother substrate may further include a barrier layer that is formed of the barrier layer material. A thickness of the mother substrate may be less than a height of the protrusions.

Each of the through holes may correspond to a protrusion of the protrusions and may extend through both the solid plastic layer and the barrier layer.

The directions may pass through centers of the through holes in a plan view of the mother substrate.

The directions may include a first direction that passes through a portion of the mother substrate that is disposed between two immediately neighboring through holes of the through holes.

The directions may include a first direction that passes through two nearest points that respectively belong to two immediately neighboring through holes of the through holes. The first direction may overlap an imaginary minimum-distance line that connects the two nearest points of the two immediately neighboring through holes.

An embodiment of the invention may be related to a display device. The display device may include a display unit that includes an electrode. The display device may further include a first substrate that overlaps the display unit. The first substrate may include a first plurality of non-uniform surface portions and a first plurality of substantially uniform surface portions. The first plurality of non-uniform surface portions may be spaced from each other and may include a first non-uniform surface portion and a second non-uniform surface portion. The first plurality of substantially uniform surface portions may have a molecular structure that is more uniform than a molecular structure of the first plurality of non-uniform surface portions. The first plurality of substantially uniform surface portions may be spaced from each other and may include a first substantially uniform surface portion that may abut each of the first non-uniform surface portion and the second non-uniform surface portion.

The display device may further include a second substrate that may overlap the first substrate with the display unit being disposed between the first substrate and the second substrate. The second substrate may include a second plurality of non-uniform surface portions and a second plurality of substantially uniform surface portions. The second plurality of non-uniform surface portions may be spaced from each other and may include a third non-uniform surface portion and a fourth non-uniform surface portion. The second plurality of substantially uniform surface portions may have a molecular structure that is more uniform than a molecular structure of the second plurality of non-uniform surface portions. The second plurality of substantially uniform surface portions may be spaced from each other and may include a second substantially uniform surface portion that may abut each of the third non-uniform surface portion and the fourth non-uniform surface portion.

The first non-uniform surface portion may be aligned with the third non-uniform surface portion in a direction perpendicular to a bottom surface of the first substrate.

An embodiment of the invention may be related to a substrate for a display device. The substrate may include the following elements: an upper surface; a lower surface facing the upper surface; and a side surface connecting the upper surface and the lower surface to each other, wherein the side surface may include a plurality of cut surfaces that are spaced apart from each other.

The side surface may further include a plurality of curved surfaces located between the cut surfaces.

The cut surfaces and the curved surfaces may be alternately arranged.

The cut surfaces may protrude with respect to the curved surfaces.

The curved surfaces may be recessed with respect to the cut surfaces.

A curved surface of curved surfaces has a semicircular shape in a plan view of the substrate.

The substrate may include a base layer and a barrier layer located on the base layer. The base layer and the barrier layer may completely overlap each other.

The cut surfaces may correspond to corner portions of the upper surface and the lower surface.

The substrate may be made of flexible plastic.

An embodiment of the invention may be related to a method for fabricating a substrate for use in a display device. The method may include the following steps: preparing a mother substrate that includes a plurality of openings; and cutting the mother substrate along the plurality of openings.

The step of preparing the mother substrate may include the following steps: preparing a support plate that includes a plurality of projection portions formed on a surface thereof; providing liquid plastic on the surface; and curing the liquid plastic.

The step of preparing the mother substrate may include separating the cured liquid plastic from the support plate after the step of curing the liquid plastic.

A height of the projection portions may be higher than a height of the liquid plastic provided on the surface.

The projection portions may correspond to the openings.

The step of cutting the mother substrate may include cutting the mother substrate along an imaginary cutting line that connects center points of the openings.

The step of cutting the mother substrate may include cutting a portion of the mother substrate located between two immediately adjacent openings.

The step of cutting the mother substrate may include cutting along an imaginary line that has a minimum length among lines connecting one point on one of two immediately adjacent openings and one point on the other of the two immediately adjacent openings.

An embodiment of the invention may be related to a display device that may include the following elements: a first substrate; a first electrode located on the first substrate; an organic light emitting layer located on the first electrode; and a second electrode located on the organic light emitting layer, wherein a side surface of the first substrate includes a plurality of first cut surfaces that are spaced apart from each other.

The display device may further include a second substrate located on the second electrode, wherein a side surface of the second substrate may include a plurality of second cut surfaces that are spaced apart from each other.

At least one of the first substrate and the second substrate may be made of flexible plastic.

### BRIEF DESCRIPTION OF THE DRAWINGS

FIG. 1 is a plan view illustrating a substrate for use in a display device according to an embodiment of the present invention.

FIG. 2 is a side view illustrating the substrate illustrated in FIG. 1 according to an embodiment of the present invention.

FIG. 3 is a plan view illustrating a step of preparing a support plate in a process of fabricating a substrate according to an embodiment of the present invention.

FIG. 4 is a side view illustrating the support plate illustrated in FIG. 3 according to an embodiment of the present invention.

FIG. 5 is a side view illustrating a step of providing liquid plastic onto a support plate in a process of fabricating a substrate according to an embodiment of the present invention.

FIG. 6 is a side view illustrating a step of forming a mother substrate through curing of liquid plastic in a process of fabricating a substrate according to an embodiment of the present invention.

FIG. 7 is a side view illustrating a step of separating a mother substrate from a support plate in a process of fabricating a substrate according to an embodiment of the present invention.

FIG. 8 is a plan view illustrating a step of cutting a mother substrate along cutting lines in a process of fabricating a substrate according to an embodiment of the present invention.

FIG. 9 is a plan view illustrating a substrate for use in a display device according to an embodiment of the present invention.

FIG. 10 is a side view illustrating the substrate illustrated in FIG. 9 according to an embodiment of the present invention.

FIG. 11 is a plan view illustrating a substrate for use in a display device according to an embodiment of the present invention.

FIG. 12 is a side view of the substrate illustrated in FIG. 11 according to an embodiment of the present invention.

FIG. 13 is a plan view of a mother substrate used in a process of fabricating a substrate according to an embodiment of the present invention.

FIG. 14 is a side and cross-sectional view illustrating a display device according to an embodiment of the present invention.

### DETAILED DESCRIPTION OF EMBODIMENTS

Embodiments of the present invention are described in detail with reference to the accompanying drawings. The present invention is not limited to the described embodiments, but can be implemented in various ways.

In the description and the drawings, the same reference numerals may indicate identical elements or analogous elements.

Although the terms “first”, “second”, and so forth” may be used to describe different elements, these elements are not limited by the terms. The terms are used to distinguish an element from one or more other constituent elements. Accordingly, in the following description, a first element may be called a second element. The description of an element as a “first” element may not require or imply the presence of a second element or other elements. The terms “first”, “second”, etc. may also be used herein to differentiate different categories of elements. For conciseness, the terms “first”, “second”, etc. may represent “first-type (or first-category)”, “second-type (or second-category)”, etc., respectively.

In the description if a first element is referred to as being “on” a second element, the first element may be directly on the other element, or one or more intervening elements may be present between the first element and the second element.

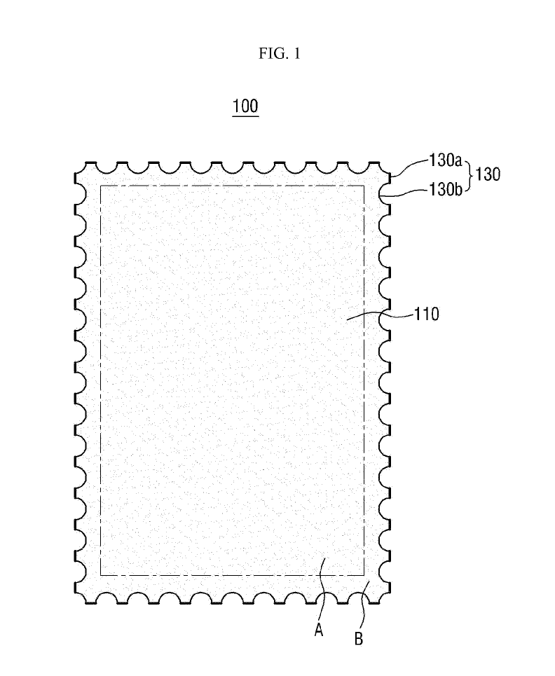

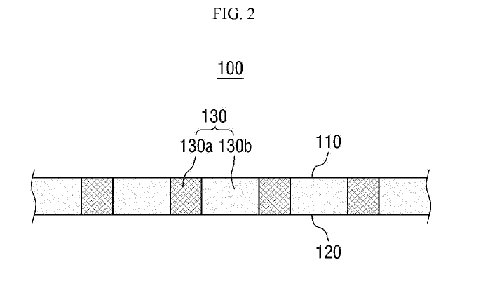

FIG. 1 is a plan view illustrating a substrate 100 (or substrate layer 100) for use in a display device according to an embodiment of the present invention, and FIG. 2 is a side view of the substrate 100.

The display device may be one of various kinds of display devices. In an embodiment, the display device may be one of a liquid crystal display, an electrophoretic display, an organic light emitting display, a FED (Filed Emission Display), a SED (Surface-conduction Electron-emitter Display), a plasma display, a cathode ray tube display, etc.

In an embodiment, the substrate 100 may be included in a display panel of the display device. In an embodiment, the substrate 100 may be included in a touch screen panel (TSP).

The substrate 100 may be flexible. In an embodiment, the shape of the substrate 100 can be changed through, for example, rolling, folding, and/or bending, by a typical user of the display device.

The substrate 100 may be made of a material having a glass transition temperature in a range of 350° C. to 500° C. The substrate 100 may not substantially deform even if a process of forming thin film transistors and/or other elements on the substrate 100 is performed at a high temperature. If the glass transition temperature of the substrate 100 is less than about 350° C., the substrate 100 may be deformed during a high-temperature process and may not satisfactorily support components disposed thereon. If the glass transition temperature of the substrate 100 exceeds about 500° C., the substrate 100 may not have sufficient processability.

The substrate 100 may include a polymer that has high heat resistance. For example, the substrate 100 may include at least one of polyethersulphone (PES), polyacrylate (PAR), polyetherimide (PEI), polyethylene napthalate (PEN), polyethyleneterepthalate (PET), polyphenylene sulfide (PPS), polyarylate, polyimide (PI), polycarbonate (PC), cellulose triacetate, cellulose acetate propionate (CAP), poly(aryleneether sulfone), and a combination some of the materials. In an embodiment, the substrate 100 may be made of polyimide (PI) with a glass transition temperature of about 450° C. and with desirable mechanical strength.

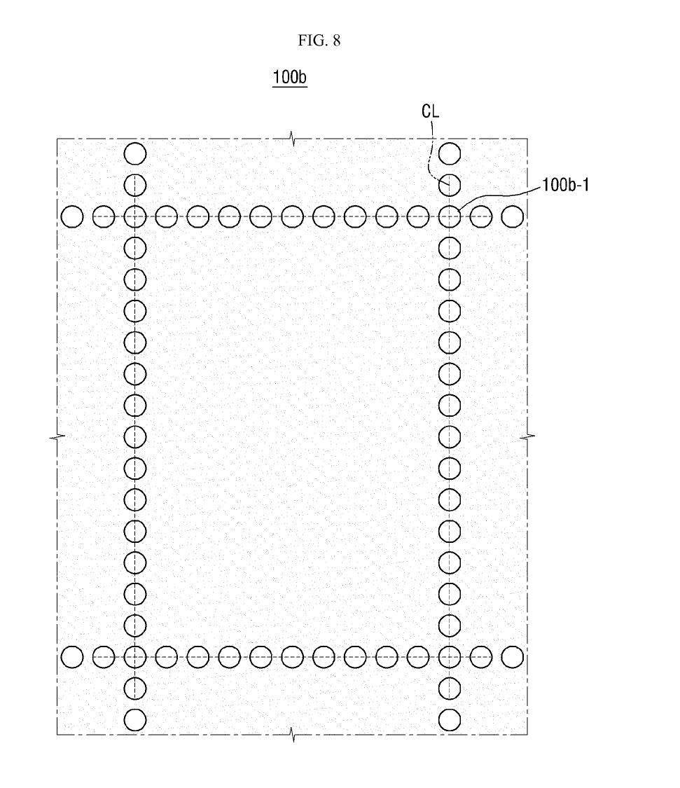

The substrate 100 may be obtained by dividing (e.g., cutting) a mother substrate 100b (illustrated in FIG. 8). The mother substrate 100b may represent an aggregation of unit substrates that are connected to each other. The substrate 100 may be a unit substrate that is separated from the other unit substrates. In an embodiment, the substrate 100 may be formed by cutting the mother substrate 100b using a knife, laser, and/or one or more of other cutting tools.

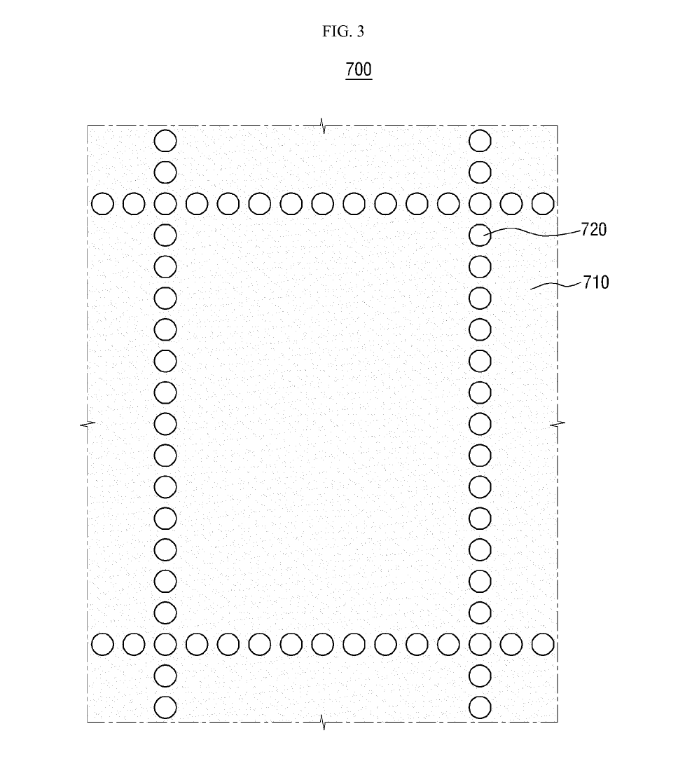

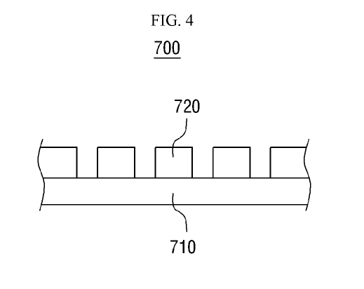

A method for forming the substrate 100 may include a step of curing liquid plastic. In an embodiment, the method may include providing liquid plastic onto a support plate 700 (illustrated in FIGS. 3 and 4), curing the liquid plastic to form the mother substrate 100b, and then cutting the mother substrate 100b. The plastic material may be provided onto the support plate 700 through printing, dropping, and/or deposition.

The substrate 100 may have a substantially rectangular shape in a plan view of the substrate 100. A fine pattern, which may include concavo-convex portions, may be formed on a surface and/or a side of the substrate 100.

The substrate 100 may include an upper surface 110, a lower surface 120, and a side surface 130. The substrate 100 may include a center portion A and an edge portion B. In an embodiment, the center portion A may correspond to a center portion of the upper surface 110 and a center portion the lower surface 120, and the edge portion B may correspond to an edge portion of the upper surface 110 and an edge portion of the lower surface 120. The edge portion B may abut the side surface 130. In an embodiment, the center portion A may overlap and/or support various elements included in the display device. In an embodiment, the center portion A may correspond to a display region of the display device configured to display an image, and the edge portion B may correspond to a non-display region of the display device not configured to display any image. In an embodiment, the center portion A may be surrounded by the edge portion B, and the edge portion B may be covered by the bezel.

The upper surface 110 and the lower surface 120 may overlap each other. The upper surface 110 and the lower surface 120 may be parallel to each other. The upper surface 110 and the lower surface 120 may have substantially the same shape. The upper surface 110 and the lower surface 120 may completely overlap each other. At least one of the upper surface 110 and the lower surface 120 may be substantially flat. In an embodiment, both the upper surface 110 and the lower surface 120 may be substantially flat. In an embodiment, at least one of the upper surface 110 and the lower surface 120 may be curved and/or may include a specific pattern.

The side surface 130 may abut each of the upper surface 110 and the lower surface 120. The side surface 130 may be in the shape of a rectangular donut. In an embodiment, the substrate 100 is substantially rectangular in a plan view of the substrate, and the side surface 130 may include four surfaces. Referring to FIG. 1, the side surface 130 may include four surfaces that are located on the upper, lower, left, and right sides in a plan view of the substrate 100.

The side surface 130 may include a non-uniform surface portion, such as a cut surface 130a, that has a non-uniform molecular structure. The cut surface 130a may be resulted from cutting the mother substrate 100b.

The cut surface 130a may include defects that are caused by the cutting process. The defects may include at least one of a crack, a depressed portion, a deformed portion, a deteriorated portion, etc. The molecular structure of the cut surface may be non-uniform. In an embodiment, the cutting process is performed using a knife, and an upper portion of the cut surface 130a may be deformed and/or depressed. If the knife has defects, such as interrupted teething, the cut surface 130a may have defects that correspond to defects of the knife.

The side surface 130 may include a plurality of non-uniform surface portions, such as a plurality of cut surfaces 130a. The cut surfaces 130a may be spaced from each other. In an embodiment, the cut surfaces 130a may be spaced from each other at equal intervals. Cut surfaces 130a located at a same side of the substrate 100 may be substantially aligned with each other and/or may be located in the same plane. The cut surfaces 130a may have the equal areas. Each of the cut surfaces 130a may be substantially rectangular. The sum of the areas of the plurality of cut surfaces 130a may be less than the whole area of the side surface 130.

The substrate 100 may have a recess at a side of the substrate 100, such that the side surface 130 may include a substantially uniform surface portion that has a substantially uniform molecular structure and abuts one or two non-uniform surface portions. In an embodiment, the substantially uniform surface portion may be a curved surface 130b that abuts one or two cut surfaces 130a. The curved surface 130b may be convex toward the center portion A. In an embodiment, the curved surface 130b may be formed when the mother substrate 100b is formed and before the mother substrate 100b is cut. The cut surface 130a is formed when the mother substrate 100b is cut after the mother substrate 110b is formed; therefore, the curved surface 130b may be formed prior to the cut surface 130a.

Since the curved surface 130b is not formed during the cutting process, the cutting process may not cause defects on the curved surface 130b, in contrast to the cut surface 130a. In an embodiment, the curved surface 130b may be substantially smooth. The molecular structure of the curved surface 130b may be substantially uniform.

The substrate 100 may have a plurality of recesses at one or more sides of the substrate 100, such that the side surface 130 may include a plurality of curved surfaces 130b. The curved surfaces 130b may be spaced from each other. In an embodiment, the plurality of curved surfaces 130b may be spaced from each other at equal intervals. The plurality of curved surfaces 130b located at a same side of the substrate 100 may be aligned with each other. The curved surfaces 130b may have equal areas. The curved surfaces 130b may appear substantially rectangular in a side view of the substrate 100. The curved surfaces 130b may be substantially semicircular in a plan view of the substrate 100. The sum of the areas of the plurality of curved surfaces 130b may be larger than the sum of the areas of the cut surfaces 130a.

A curved surface 130b (and a corresponding recess) may be located between the two cut surfaces 130a. In an embodiment, each of the curved surfaces 130b may be located between two cut surfaces 130a. The curved surfaces 130b and the cut surfaces 130a may be alternately arranged. The curved surfaces 130b and the cut surfaces 130a may be continuously arranged. A curved surface 130b may abut at least one cut surface 130a. The sum of the areas of the curved surfaces 130b and the areas of the cut surfaces 130a may be the total area of the side surface 130. Further, a cut surface 130a may be located farther from the center portion A of the substrate 100 than a portion of a curved surface 130b that abuts the cut surface.

A curved surface 130b may be substantially semicircular in a plan view of the substrate 100. That is, a boundary line between the curved surface 130b and each of the upper surface 110 and the lower surface 120 may be substantially semicircular. The substrate 100 may include a semicircular recessed portion that includes the curved surface 130b.

According to an embodiment of the present invention, the formation of curved surfaces 130b may minimize the areas of the cut surfaces 130a. Therefore, damages and/or defects that may occur on the substrate 100 during the process of cutting the mother substrate 100b may be minimized Advantageously, the substrate 100 may be satisfactorily structurally robust.

According to an embodiment of the present invention, given the recesses (or cavities) associated with the curved surfaces 130b, the projecting portions associated with the cut surfaces 130a may substantially absorb impacts applied to the substrate 100. Advantageously, the display device that includes the substrate 100 may have satisfactory impact resistance.

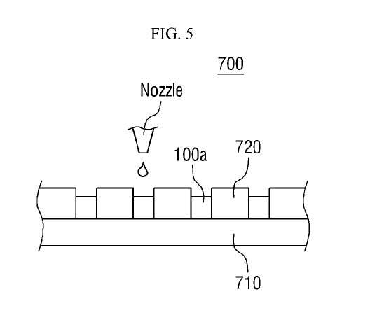

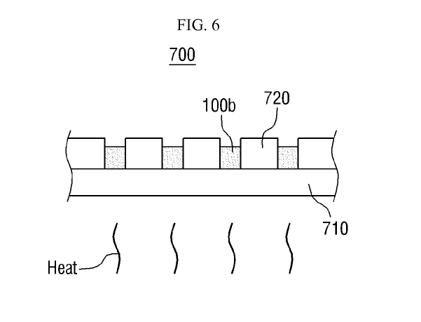

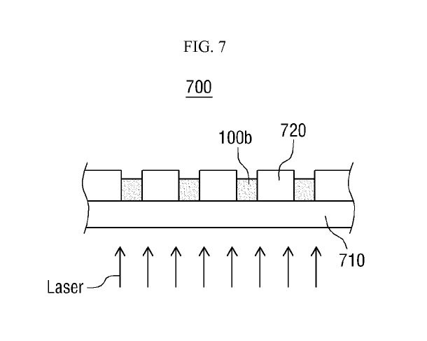

A method for fabricating the substrate 100 illustrated in FIG. 1 according to one or more embodiments of the present invention is described with reference to FIGS. 3 to 8. FIG. 3 is a plan view illustrating a step of preparing a support plate 700 in the method for fabricating the substrate 100. FIG. 4 is a side view illustrating the support plate 700 illustrated in FIG. 3. FIG. 5 is a side view illustrating a step of providing liquid plastic onto the support plate 700 in the method for fabricating the substrate 100. FIG. 6 is a side view illustrating a step of forming a mother substrate 100b through curing of the liquid plastic in the method for fabricating the substrate 100. FIG. 7 is a side view illustrating a step of separating the mother substrate 100b from the support plate 700 in the method for fabricating the substrate 100. FIG. 8 is a plan view illustrating a step of cutting the mother substrate 100b along cutting lines CL in the method for fabricating the substrate 100. The same reference numerals may be used for elements that are substantially identical or analogous to elements illustrated in FIGS. 1 and 2.

Referring to FIGS. 3 and 4, a support plate 700 may be prepared for forming the mother substrate 100b illustrated in FIG. 8. The support plate 700 may serve as a frame for supporting liquid plastic for forming the mother substrate 100b and for setting the shape of the mother substrate 100b.

The support plate 700 may include a support portion 710 and a plurality of protrusions 720.

The support portion 710 may be a rectangular prism plate. The support portion 710 may be made of transparent glass. The support portion 710 may be electrically insulating. The support portion 710 may be made of at least one of glass, quartz, ceramic, and plastic. The support portion 710 may be a substantially rigid substrate configured to stably support a liquid mother substrate 100a (illustrated in FIG. 5) for forming the mother substrate 100b.

The protrusions 720 may protrude from a surface of the support portion 710. The material(s) of the protrusions 720 may be the same as or different from the material(s) of the support portion 710. The protrusions 720 may be integrally formed with the support portion 710. The protrusions 720 may be separable and/or removable from the support portion 710 without damage to the protrusions 720 and/or the support portion 710.

The protrusions 720 may be spaced from each other on a portion of the support portion 710 that corresponds to a side surface 130 of the substrate 100. The protrusions 720 may correspond to curved portions 130b of the substrate 100. The protrusions 720 may correspond to the openings 100b-1 (or through holes 100b-1) of the mother substrate 110b (illustrated in FIG. 8). The protrusion 720 may determine the shape(s) of the openings 100b-1 of the mother substrate 100b. The protrusion 720 may include cylindrical columns or columns that have one or more other shapes. For example, the protrusion 720 may include rectangular prism columns. The area of protrusion 720 in a plan view of the support plate 700 may be substantially equal to the area of an opening 100b-1 in a plan view of the mother substrate 100b. An area of a portion of the support plate that is surrounded by the plurality of protrusions 720 may be substantially equal to the area of the substrate 100.

Referring to FIG. 5, after the support plate 700 has been prepared, liquid plastic may be provide onto the surface of the support portion 710 on which the protrusions 720 are disposed. The liquid plastic may include at least one of polyethersulphone (PES), polyacrylate (PAR), polyetherimide (PEI), polyethylene napthalate (PEN), polyethyleneterepthalate (PET), polyphenylene sulfide (PPS), polyarylate, polyimide (PI), polycarbonate (PC), cellulose triacetate, cellulose acetate propionate (CAP), poly(aryleneether sulfone), and a combination two or more of the materials.

The provided liquid plastic may fill a space defined by the protrusions 720 on the surface of the support portion 710 without exceeding the (minimum) height of the protrusions 720. The liquid plastic may surround the protrusions 720 to form the liquid mother substrate 100a. Since the height of the protrusions 720 is higher than the height (or thickness) of the liquid plastic (or the liquid mother substrate 100a), the liquid plastic may not cover end portions of the protrusions 720. Therefore, through holes corresponding to the protrusions 720 may be formed in the liquid mother substrate 100a.

Referring to FIG. 5 and FIG. 6, the liquid mother substrate 100a may be cured to become the mother substrate 100b. In order to cure the liquid plastic of the liquid mother substrate 100a, predetermined heat may be applied to the support plate 700 and the liquid mother substrate 100a for a predetermined length of time. As a result of the curing step, the mother substrate 100b may be formed with opening 100b-1 (or through holes 100b-1) corresponding to the protrusions 720. The mother substrate 100b may be an aggregation of unit substrates that are connected to each other.

Although not illustrated in FIG. 6, in an embodiment, after the curing step, elements for constituting display devices, for example, organic light emitting elements, may be formed on the mother substrate 100b. The elements may be formed on portions of the mother substrate 100b that are surrounded by the protrusions 720. The elements may be formed using one or more deposition processes and/or one or more ink jet printing processes.

Referring to FIG. 7, after the liquid plastic (or the liquid mother substrate 100a) is cured, the formed mother substrate 100b may be separated from the support plate 700. That is, the support plate 700 may be removed from the mother substrate 100b after the mother substrate 100b is formed.

The mother substrate 100b and the support plate 700 may be separated through irradiation of laser. The laser may be irradiated onto an interface between the support plate 700 and the mother substrate 100b. As a result, the adhesive force of the interface between the support plate 700 and the mother substrate 100b is weakened, and thus the support plate 700 and the mother substrate 100b can be separated from each other.

Although not illustrated in FIG. 7, in an embodiment, after the separation step, elements for constituting display devices may be formed on the mother substrate 100b. The elements may be formed using one or more deposition processes and/or one or more ink jet printing processes.

Referring to FIG. 8, after the mother substrate 100b is separated from the support plate 700, the substrate 100 and other substrates analogous to the substrate 100 may be obtained through cutting of the mother substrate 100b along arrangement directions of the openings 100b-1 (or through holes 100b-1). In an embodiment, the mother substrate 100b may be cut along a cutting line CL (or an imaginary path) that that connects center points of the openings 100b-1, which may be circle-shaped in a plan view of the mother substrate 100b. As illustrated in FIG. 8, the substrate 100 may be obtained by cutting the mother substrate 100b along four straight lines that connect the centers of a set of openings 100b-1 arranged substantially as a rectangle in the plan view of the mother substrate 100b. An opening 100b-1 may be substantially symmetrical with respect to an associated cutting line CL. A portion of the mother substrate 100b between each pair of two immediately adjacent openings 100b-1 may be cut. The mother substrate 100b may be cut along a line having the minimum length among lines connecting one point of one of the two immediately adjacent openings 100b-1 and one point on the other of the two immediately adjacent openings 100b-1.

According to an embodiment of the present invention, the total area of the cut surfaces 130a (or non-uniform surface portions) may be minimized Therefore, damages and/or defects that may occur on the substrate 100 during the process of cutting the mother substrate 100b may be minimized. Advantageously, the substrate 100 may be satisfactorily structurally robust.

According to an embodiment of the present invention, given the recesses (or cavities) associated with the curved surfaces 130b, the projecting cut surfaces 130a may substantially absorb impacts applied to the substrate 100. Advantageously, the display device that includes the substrate 100 may have satisfactory impact resistance.

According to an embodiment of the present invention, since the cut area (and/or cut length) is minimized, pressure that is necessary for cutting the mother substrate 100b may be minimized. Advantageously, process efficiency (e.g., energy efficiency) associated with fabrication of the substrate 100 may be maximized.

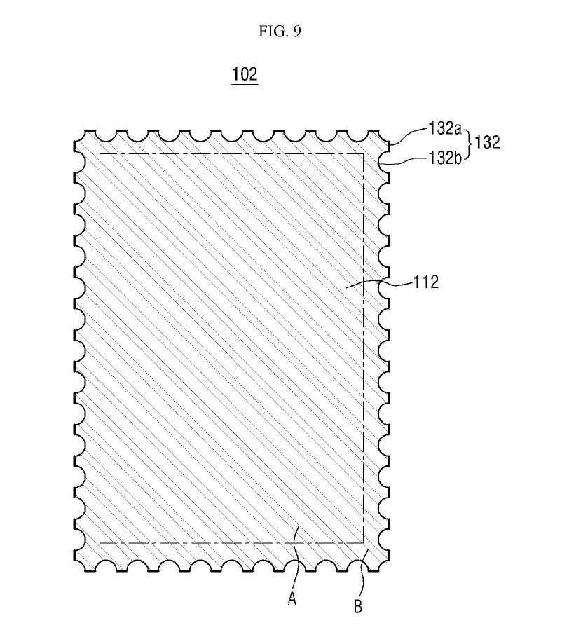

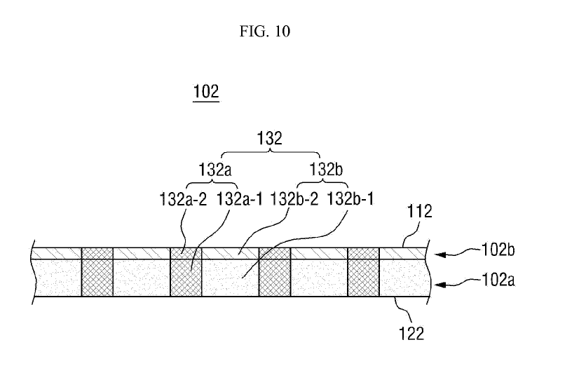

FIG. 9 is a plan view illustrating a substrate 102 for use in a display device according to an embodiment of the present invention. FIG. 10 is a side view illustrating the substrate 102 illustrated in FIG. 9.

The substrate 102 may be associated with features, fabrication methods, and advantages that may be substantially identical to or analogous to features, fabrication methods, and advantages that are associated with the substrate 100 discussed with reference to FIGS. 1 to 8. Additionally or alternatively, the substrate 102 may have a multilayer structure. In an embodiment, the substrate 102 may include a base layer 102a and a barrier layer 102b, each being a substrate layer of the display device. The base layer 102a and the barrier layer 102b may be sequentially laminated.

The substrate 102 may include an upper surface 112, a lower surface 122, and a side surface 132. The upper surface 112 may be an upper surface of the barrier layer 102b, and the lower surface 122 may be a lower surface of the base layer 102a. The side surface 132 may include both side surfaces of the barrier layer 102b and the base layer 102a.

The side surface 132 may include a plurality of non-uniform surface portions (e.g., cut surfaces 132a) having non-uniform molecular structure and may include a plurality of substantially uniform surface portions (e.g., curved surfaces 132b) having substantially uniform molecular structures. The cut surface 132a may include a cut surface 132a-1 of the base layer 102a and may include a cut surface 132a-2 of the barrier layer 102b. The curved surface 132b may include a curved surface 132b-1 of the base layer 102a and may include a curved surface 132b-2 of the barrier layer 102b. The cut surface 132a-1 of the base layer 102a and the cut surface 132a-2 of the barrier layer 102b may completely overlap each other in a direction perpendicular to the upper surface 112. The curved surface 132b-1 of the base layer 102a and the curved surface 132b-2 of the barrier layer 102b may also completely overlap each other in the direction perpendicular to the upper surface 112. The base layer 102a and the barrier layer 102b may completely overlap each other.

The base layer 102a may have features that are substantially the same as features of the substrate 100 illustrated in FIGS. 1 and 2. The base layer 102a may be made of flexible plastic and may be formed through curing of liquid plastic. The cut surface 132a-1 of the base later 102a and the curved surface 132b-1 of the base layer 102a may be analogous to the cut surface 130a of the substrate 100 and the curved surface 130b of the substrate 100, respectively. The lower surface of the base layer 102a may correspond to the lower surface 122 of the substrate 102.

The barrier layer 102b may be formed on the base layer 102a. The barrier layer 102b may be made of an inorganic material, such as SiOx, SiNx, SiON, AlO, or AlON, or may be made of an organic material, such as acryl or polyimide. The barrier layer 102b may include organic material layers and inorganic material layers that may be alternately laminated. The barrier layer 102b may intercept oxygen and moisture for protecting components of the display device, may prevent diffusion of the moisture or impurities generated on the base layer 102a, and/or may determine the heat transfer speed for one or more process steps, for example, semiconductor crystallization, in manufacturing the display device.

The barrier layer 102b may have the cut surface 132a-2 and the curved surface 132b-2. The upper surface of the barrier layer 102b may be the upper surface 112 of the substrate 102.

The method for forming a mother layer that includes the barrier layer 102b may include steps that may be substantially identical to or analogous to steps in the method for forming a mother layer that includes the base layer 102a. The mother layer that includes base layer 102a may be formed by providing (e.g., printing, spraying, and/or depositing) and curing the liquid plastic on a support plate (analogous to the support plate 700). The mother layer that includes the barrier layer 102b may be formed by depositing one or more associated materials, for example, SiOx, onto the mother layer that includes the base layer 102a and has been formed on the support plate, onto the same support plate after the support plate has been removed from the mother layer that includes the base layer 102a, or onto a different support plate.

In an embodiment, the material(s) for forming the barrier layer 102b may be deposited on the base layer 102a after the curing of the liquid plastic on a support plate (analogous to the support plate 700), such that the base layer 102a may be disposed between the barrier layer 102b and the support portion of the support plate. Subsequently, the support plate may be removed from the substrate 102, which includes the base layer 102a and the barrier layer 102b. The (minimum) height of the protrusions of the support plate may be greater than or equal to the thickness of the substrate 102, i.e., the sum of the thickness of the base layer 102a and the barrier layer 102b.

In an embodiment, the substrate 102 may be obtained by cutting a mother substrate that includes both the mother layer that includes the base layer 102a and the mother layer that includes the barrier layer 102b.

According an embodiment of the present invention, cut areas associated with each of the mother layer that includes the base layer 102a and the mother layer that includes the barrier layer 102b may be minimized. Accordingly, damages and/or defects that on the base layer 102a and damages and/or defects on the barrier layer 102b can be minimized

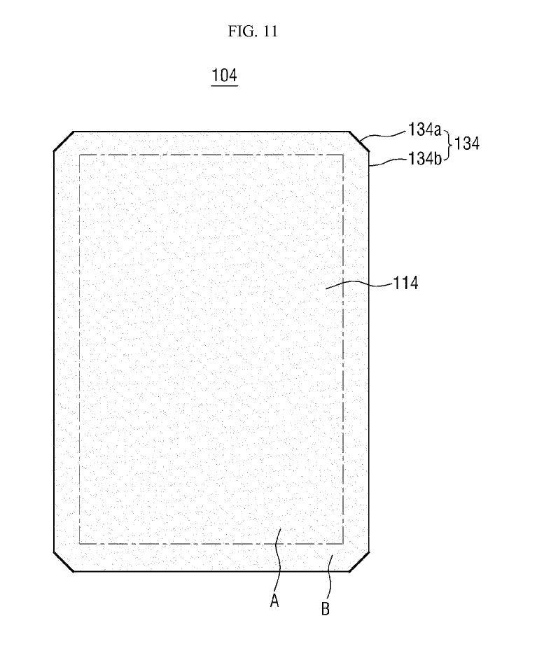

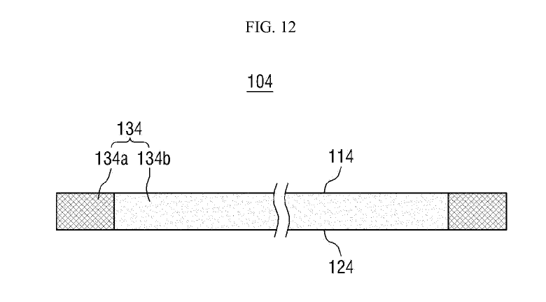

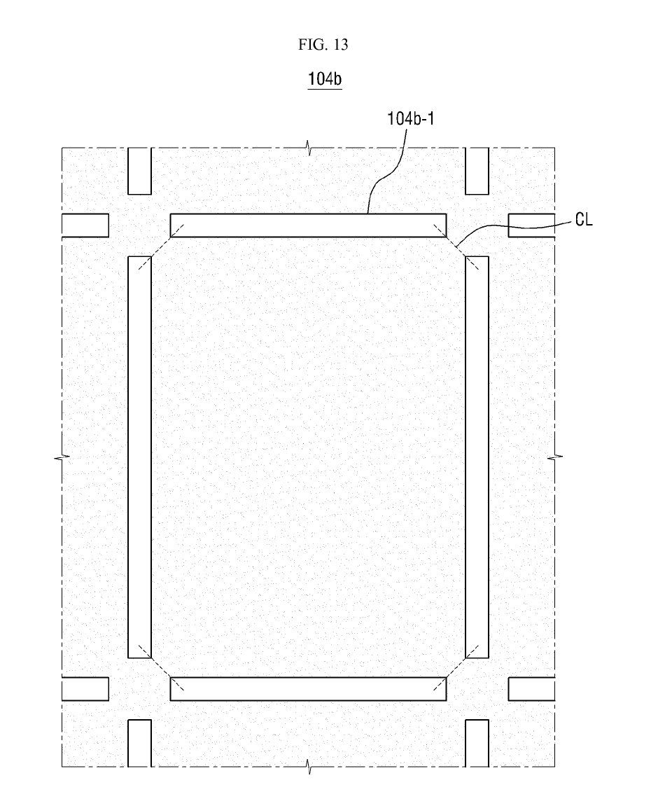

FIG. 11 is a plan view illustrating a substrate 104 (or substrate layer 104) for use in a display device according to an embodiment of the present invention. FIG. 12 is a side view illustrating the substrate 104 illustrated in FIG. 11. FIG. 13 is a plan view illustrating a mother substrate 104b used in a process of fabricating the substrate 104 illustrated in FIG. 11. The substrate 104 may be associated with features, fabrication methods, and advantages that may be substantially identical to or analogous to features, fabrication methods, and advantages that are associated with the substrate 100 and/or the substrate 102 discussed with reference to FIGS. 1 to 10.

Referring to FIGS. 11 and 12, the substrate 104 may include a cut surface 134a formed at a corner (e.g., a chamfered corner) of the substrate 104. The substrate 104 may include an upper surface 114, a lower surface 124, and a side surface 134. The side surface 134 may include a non-uniform surface portion (e.g., a cut surface 134a) that has a non-uniform molecular structure and may include a substantially uniform surface portion (e.g., a planarization surface 134b) that has a substantially uniform molecular structure. The cut surface 134a may be formed at positions that correspond to corner portions of the upper surface 114 and the lower surface 124.

Referring to FIG. 13, the substrate 104 and other substrates analogous to the substrate 104 may be obtained through cutting of the mother substrate 104b. The mother substrate 104b may include features that may be similar to features of the mother substrate 100b discussed with reference to FIG. 8. Nevertheless, the shape(s) of the openings 104b-1 may be different from the shape(s) of the openings 100b-1. The shape of the openings 104b-1 may be a rectangular in a plan view of the mother substrate 104b. Four slits may be arranged to surround a region of the mother substrate 104b that corresponds to the substrate 104. By cutting portions of the mother substrate 104 between two immediately adjacent openings 104b-1 along a minimum-distance line, the substrate 104 may be formed.

According to an embodiment of the present invention, the cut surfaces 134a exist only at the four chamfered corners of the substrate 104. Therefore, the cut-associated damages and/or defects that remain on the substrate 104 may be minimized. The chambered structure of the substrate 104 may optimize impact resistance of the display device that includes the substrate 104.

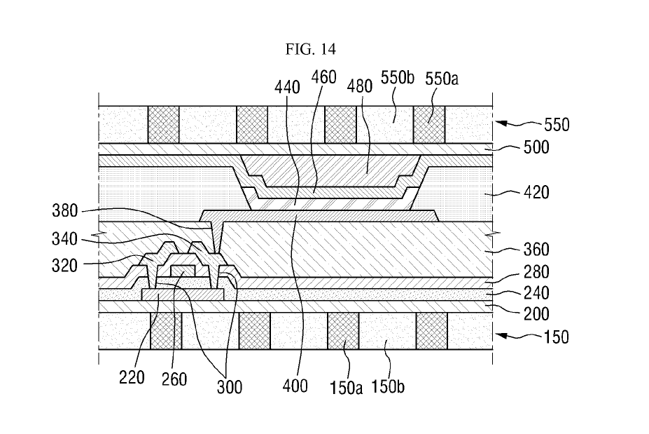

FIG. 14 is a side and cross-sectional view illustrating a display device according to an embodiment of the present invention.

The display device may include a first substrate 150, a first buffer layer 200, a semiconductor layer 220, a gate insulating film 240, a gate electrode 260, an interlayer insulating film 280, contact holes 300, a source electrode 320, a drain electrode 340, a planarization film 360, a via-hole 380, a first electrode 400 (e.g., a pixel electrode), a pixel-defining film 420, an organic light emitting layer 440, a second electrode 460 (e.g., a common electrode), a spacer 480, a second buffer layer 500, and a second substrate 550.

One or more of the first substrate 150 and the second substrate 550 may be substantially identical to or analogous to one or more of the substrate 100, the substrate 102, and the substrate 104 describe above. In an embodiment, the cut surface 150a of the first substrate 150 and the cut surface 550a of the second substrate 550 may be substantially identical to or analogous to the cut surface 130a of the substrate 100. In an embodiment, the curved surface 150b of the first substrate 150 and the curved surface 550b of the second substrate 550 may be substantially identical to or analogous to the curved surface 130b of the substrate 100.

The other constituent elements of the display device may be disposed between the first substrate 150 and the second substrate 550. For convenience and clarity in explanation, in an embodiment illustrated in FIG. 14, the first substrate 150 and the second substrate 550 are illustrated in a side view, and the constituent elements other than the first substrate 150 and the second substrate 550 are illustrated in a cross-sectional view.

The first buffer layer 200 may be formed on the first substrate 150. The first buffer layer 200 may prevent metal atoms or impurities from diffusing into the semiconductor layer 220. The first buffer layer 200 may provide a substantially flat surface over the first substrate 150. The first buffer layer 200 may be made of silicon compound. For example, the first buffer layer 200 may include at least one of silicon oxide, silicon nitride, silicon oxynitride, silicon oxycarbide, and silicon carbonitride. The first buffer layer 200 may have a single-layer structure or a multilayer structure including. The first buffer layer 200 may have features and advantages that are identical to or analogous to features of the barrier layer 102b described above. In an embodiment, the first buffer layer 200 may be omitted, depending on the surface flatness and/or constituent materials of the first substrate 150.

The semiconductor layer 220 may be formed on the first buffer layer 200. Although not illustrated, the semiconductor layer 220 may include a source region, a drain region, and a channel region. The semiconductor layer 220 may be made of polysilicon or oxide semiconductor.

The gate insulating film 240 may cover the semiconductor layer 220 and the first buffer layer 200. The gate insulating film 240 may be made of silicon oxide or metal oxide. The metal oxide may include at least one of hafnium oxide (HfOx), aluminum oxide (AlOx), zirconium oxide (ZrOx), titanium oxide (TiOx), and tantalum oxide (TaOx).

The gate electrode 260 may be formed on the gate insulating film 240. The gate electrode 260 may overlap the semiconductor layer 220. The gate electrode 260 may include at least one of metal, an alloy, metal nitride, conductive metal oxide, and a transparent conductive material.

The interlayer insulating film 280 may be formed on the gate insulating film 240 to cover the gate electrode 260. The interlayer insulating film 280 may be formed on the gate insulating film 240 along a profile of the gate electrode 260 with a substantially uniform thickness. The interlayer insulating film 280 may be made of silicon compound.

The contact holes 300 may go through the interlayer insulating film 280 and the gate insulating film 240. The contact hole 300 may expose the source region and the drain region of the semiconductor layer 220.

The source electrode 320 and the drain electrode 340 may be formed on the interlayer insulating film 280. The source electrode 320 and the drain electrode 340 may be spaced apart from each other and may be insulated from the gate electrode 260 by the interlayer insulating film 280. The source electrode 320 and the drain electrode 340 may respectively overlap the source region and the drain region. The source electrode 320 and the drain electrode 340 may extend through the contact holes 300 and may directly contact the source region and the drain region, respectively. The source electrode 320 and the drain electrode 340 may include at least one of metal, an alloy, metal nitride, conductive metal oxide, and a transparent conductive material.

The planarization film 360 may be formed on the interlayer insulating film 280 to cover the source electrode 320 and the drain electrode 340. The planarization film 360 may substantially cover the source electrode 320 and the drain electrode 340. The planarization film 360 may be formed using an organic material or an inorganic material.

The via-hole 380 may go through the planarization film 360 and may expose a part of the drain electrode 340.

The first electrode 400 (or pixel electrode 400) may fill the via-hole 380 of the planarization film 360 and may be connected to the drain electrode 340 through the via-hole 380. A portion of the first electrode 400 may be formed on the planarization film 360. The first electrode 400 may include a conductive material.

The pixel-defining film 420 may be formed on the planarization film 360 and the first electrode 400. The pixel-defining film 420 may include at least one open region that exposes the first electrode 400. The pixel-defining film 420 may be formed using an organic material or an inorganic material. The organic material may include at least one of photoresist, polyacryl-based resin, polyimide-based resin, and acryl-based resin. The inorganic material may include a silicon compound.

The organic light emitting layer 440 may be located on the open region that is defined by the pixel-defining film. The organic light emitting layer 440 may be interposed between the first electrode 400 and the second electrode 460. The organic light emitting layer 440 may have a multilayer structure that includes a light emitting layer EL, a hole injection layer HIL, a hole transport layer HTL, an electron transport layer ETL, and an electron injection layer TIL. If an electric field is applied to the organic light emitting layer 440, the organic light emitting layer 440 may emit light of a specific color.

The second electrode 460 may be formed on the organic light emitting layer 440 and the pixel-defining film 420 with a substantially uniform thickness. The second electrode 460 may be made of a conductive material that is different from the material of the first electrode 400.

The spacer 480 may be formed on the second electrode 460. The spacer 480 may affect the thickness of the whole display device. The spacer 480 may be made of a material that is identical to or similar to a material of the pixel-defining film 420.

The second buffer layer 500 may be located on and may contact the second electrode 460 and the spacer 480. The second buffer layer 500 may be located between the second substrate 550 and each of the second electrode 460 and the spacer 480. The second buffer layer 500 may be made of substantially the same material as the first buffer layer 200.

According to embodiments of the invention, the display device may have a robust and stable structure that is supported by the first substrate 150 and the second substrate 550. Advantageously, the display device may be able to provide satisfactory image quality and may have satisfactory impact resistance and durability.

Although embodiments of the present invention have been described for illustrative purposes, those skilled in the art will appreciate that various modifications, additions and substitutions are possible, without departing from the scope and spirit of the invention according to the accompanying claims.

What is claimed is:

1. A substrate for use in a display device, the substrate comprising:
a plurality of non-uniform surface portions, the non-uniform surface portions being spaced from each other and including a first non-uniform surface portion and a second non-uniform surface portion; and
a plurality of substantially uniform surface portions having a molecular structure that is more uniform than a molecular structure of the plurality of non-uniform surface portions, the substantially uniform surface portions being spaced from each other and including a first substantially uniform surface portion that abuts each of the first non-uniform surface portion and the second non-uniform surface portion.

2. The substrate of claim 1, wherein the first substantially uniform surface portion is a curved surface portion.

3. The substrate of claim 1, wherein the non-uniform surface portions and the substantially uniform surface portion are alternately arranged.

4. The substrate of claim 1, wherein the first substantially uniform surface portion is recessed with respect to the first non-uniform surface portion.

5. The substrate of claim 1, wherein the first non-uniform surface portion is located at a first side of the substrate, and wherein the first substantially uniform surface portion is a surface portion of a recess at the first side of the substrate.

6. The substrate of claim 1, wherein the first substantially uniform surface portion is substantially semicircular in a plan view of the substrate.

7. The substrate of claim 1, wherein the non-uniform surface portions are respectively located at chamfered corners of the substrate.

8. The substrate of claim 1, wherein each of the first non-uniform surface portion and the second non-uniform surface portion is slanted with respect to the first substantially uniform surface portion in a plan view of the substrate.

9. The substrate of claim 1, wherein the first substantially uniform surface portion includes a surface portion of a recess of a barrier layer of the substrate and a surface portion of a recess of a base layer of the substrate.

10. A method for fabricating a display device substrate, the method comprising:
preparing a mother substrate that includes a plurality of through holes; and
cutting the mother substrate in directions that pass through the through holes to separate the display device substrate from other portions of the mother substrate.

11. The method of claim 10, further comprising:
preparing a support plate that includes a support portion and a plurality of protrusions disposed on the support portion;
providing liquid plastic on the support portion such that the liquid plastic fills a space defined by the protrusions and such that each of the protrusions is surrounded by the liquid plastic;
curing the liquid plastic into a solid plastic layer; and
removing the support plate from the mother substrate, wherein the mother substrate includes or is the solid plastic layer.

12. The method of claim 11, wherein a thickness of the solid plastic layer is less than a height of the protrusions, and wherein the protrusions correspond to the through holes.

13. The method of claim 11, further comprising:
providing a barrier layer material on the solid plastic layer such that each of the protrusions is surrounded by the barrier layer material, wherein the barrier layer material is different form the liquid plastic, and wherein the mother substrate further includes a barrier layer that is formed of the barrier layer material, and wherein a thickness of the mother substrate is less than a height of the protrusions.

14. The method of claim 13, wherein each of the through holes corresponds to a protrusion of the protrusions and extends through both the solid plastic layer and the barrier layer.

15. The method of claim 10, wherein the directions pass through centers of the through holes in a plan view of the mother substrate.

16. The method of claim 10, wherein the directions include a first direction that passes through a portion of the mother substrate that is disposed between two immediately neighboring through holes of the through holes.

17. The method of claim 10, wherein the directions include a first direction that passes through two nearest points that respectively belong to two immediately neighboring through holes of the through holes.

18. A display device comprising:
a display unit that includes an electrode; and
a first substrate that overlaps the display unit, the first substrate including a first plurality of non-uniform surface portions and a first plurality of substantially uniform surface portions, the first plurality of non-uniform surface portions being spaced from each other and including a first non-uniform surface portion and a second non-uniform surface portion, the first plurality of substantially uniform surface portions having a molecular structure that is more uniform than a molecular structure of the first plurality of non-uniform surface portions, the first plurality of substantially uniform surface portions being spaced from each other and including a first substantially uniform surface portion that abuts each of the first non-uniform surface portion and the second non-uniform surface portion.

19. The display device of claim 18, further comprising:
a second substrate that overlaps the first substrate with the display unit being disposed between the first substrate and the second substrate, the second substrate including a second plurality of non-uniform surface portions and a second plurality of substantially uniform surface portions, the second plurality of non-uniform surface portions being spaced from each other and including a third non-uniform surface portion and a fourth non-uniform surface portion, the second plurality of substantially uniform surface portions having a molecular structure that is more uniform than a molecular structure of the second plurality of non-uniform surface portions, the second plurality of substantially uniform surface portions being spaced from each other and including a second substantially uniform surface portion that abuts each of the third non-uniform surface portion and the fourth non-uniform surface portion.

20. The display device of claim 19, wherein the first non-uniform surface portion is aligned with the third non-uniform surface portion in a direction perpendicular to a bottom surface of the first substrate.
